(19) United States
(12) Patent Application Publication
(10) Pub. No.: US 2026/0220039 A1
(43) Pub. Date: Jul. 30, 2026

(54) ELECTRONIC SYSTEMS, MEMORY SYSTEMS, AND METHODS OF OPERATING THEREOF

(71) Applicant: YANGTZE MEMORY TECHNOLOGIES CO., LTD., Wuhan (CN)

(72) Inventors: Tianyi WANG, Wuhan (CN); Mo CHENG, Wuhan (CN)

(21) Appl. No.: 19/236,912

(22) Filed: Jun. 12, 2025

(30) Foreign Application Priority Data
Jan. 26, 2025 (CN) 2025101249965

(51) Int. Cl. G06F 12/02; G06F 3/06

(52) U.S. Cl. CPC G06F 12/0246; G06F 3/0616; G06F 3/0644; G06F 3/0652; G06F 3/0679; G06F 2212/7202; G06F 2212/7205; G06F 2212/7208

(57) ABSTRACT

Implementations of the present disclosure disclose an electronic system, a memory system and an method of operating thereof. The electronic system includes a host and a memory system that supports a flexible data placement function; the memory system includes a memory controller and a memory device coupled to the memory controller; the host is configured to: send a first command; the first command carries information related to a relative lifetime of data written by a specified reclaim unit handle; the memory controller is configured to: receive the first command; and perform a garbage collection operation on the data written by the specified reclaim unit handle based on the information related to the relative lifetime.

### CROSS-REFERENCE TO RELATED APPLICATIONS

The present disclosure claims priority to Chinese Patent Application No. 2025101249965, which was filed January 26, 2025, and is hereby incorporated herein by reference in its entirety.

### FIELD OF TECHNOLOGY

Implementations of the present disclosure relate to the field of semiconductor technologies, and relate to, but are not limited to, an electronic system, a memory system, and an method of operating thereof.

### BACKGROUND

With the rapid development of data storage technology, more and more data memory systems are appearing in electronic devices used by people, such as solid state drives (SSD). SSD has been widely used in fields of military, automotive, industrial, medical, and aviation due to the characteristics of fast read and write speed, anti-vibration, low power consumption, no noise, low heat, and lightweight.

### SUMMARY

The implementations of the present disclosure provide an electronic system, a memory system, and an method of operating thereof.

According to a first aspect, an implementation of the present disclosure provides an electronic system, comprising a host and a memory system that supports a flexible data placement function; the memory system comprises a memory controller and a memory device coupled to the memory controller; the host is configured to: send a first command; the first command carries information related to a relative lifetime of data written by a specified reclaim unit handle; the memory controller is configured to: receive the first command; and perform a garbage collection operation on the data written by the specified reclaim unit handle based on the information related to the relative lifetime.

According to a second aspect, an implementation of the present disclosure provides an method of operating a memory system, where the memory system supports a flexible data placement function, and the method comprises: receiving a first command; the first command carries information related to a relative lifetime of data written by a specified reclaim unit handle; and performing a garbage collection operation on the data written by the specified reclaim unit handle based on the information related to the relative lifetime.

According to a third aspect, an implementation of the present disclosure provides a memory system, where the memory system supports a flexible data placement function, and the memory system comprises a memory controller and a memory device coupled to the memory controller; the memory controller is configured to: receive a first command; the first command carries information related to a relative lifetime of data written by a specified reclaim unit handle; and perform a garbage collection operation on the data written by the specified reclaim unit handle based on the information related to the relative lifetime.

### BRIEF DESCRIPTION OF THE DRAWINGS

In the drawings, like reference numbers may describe similar components in different views. Like reference numbers with different letter suffixes may represent different examples of similar components. The drawings illustrate various implementations discussed herein by way of example and not limitation.

FIG. 1 is a first schematic diagram of an example system having a memory system according to an implementation of the present disclosure.

FIG. 2 is a schematic diagram of an example memory card having a memory system according to an implementation of the present disclosure.

FIG. 3 is a schematic diagram of an example solid state drive with a memory system according to an implementation of the present disclosure.

FIG. 4 is a schematic diagram of an example memory device comprising a peripheral circuit according to an implementation of the present disclosure.

FIG. 5 is a schematic diagram of an example memory comprising a storage array and a peripheral circuit according to an implementation of the present disclosure.

FIG. 6 is a second schematic diagram of an example system having a memory system according to an implementation of the present disclosure.

FIG. 7 is a first schematic diagram of a memory system that supports a flexible data placement function according to an implementation of the present disclosure.

FIG. 8 is a first schematic diagram of configuration of a reclaim group according to an implementation of the present disclosure.

FIG. 9 is a second schematic diagram of configuration of a reclaim group according to an implementation of the present disclosure.

FIG. 10 is a third schematic diagram of configuration of a reclaim group according to an implementation of the present disclosure.

FIG. 11 is a first schematic diagram of garbage collection according to an implementation of the present disclosure.

FIG. 12 is a second schematic diagram of garbage collection according to an implementation of the present disclosure.

FIG. 13 is a second schematic diagram of a memory system that supports a flexible data placement function according to an implementation of the present disclosure.

FIG. 14 is a third schematic diagram of garbage collection according to an implementation of the present disclosure.

FIG. 15 is a schematic diagram of a process of creating a namespace according to an implementation of the present disclosure.

FIG. 16 is a schematic diagram of a process of a write operation according to an implementation of the present disclosure.

FIG. 17 is a schematic flowchart of an method of operating a memory system according to an implementation of the present disclosure.

FIG. 18 is a schematic diagram of a process of a garbage collection operation according to an implementation of the present disclosure.

### DETAILED DESCRIPTION

Example implementations disclosed in the present disclosure will be described in more detail below with reference to the accompanying drawings. Although example implementations of the present disclosure are shown in the accompanying drawings, the present disclosure may be implemented in various forms and should not be limited to the detail implementations set forth herein. Rather, these implementations are provided so that the present disclosure can be more thoroughly understood and the scope disclosed in the present disclosure can be fully conveyed to those skilled in the art.

In the following description, numerous details are given in order to provide a more thorough understanding of the present disclosure. However, it will be apparent to one skilled in the art that, the present disclosure may be practiced without one or more of these details. In other examples, in order to avoid confusion with the present disclosure, some technical features known in the art are not described; for example, not all features of the actual implementations are described here, and well-known functions and structures are not described in detail.

In the drawings, like reference numerals refer to like elements throughout.

Spatial relation terms such as “beneath,” “below,” “lower,” “under”, “above,” “upper,” etc., may be used herein for ease of description to describe the relationship between one element or feature and other elements or features shown in the figures. It should be appreciated that, in addition to the orientations shown in the figures, the spatial-relation terms intent to also include different orientations of the devices in use and operation. For example, if the devices in the figures are flipped, then described as “below” or “under” or “beneath” other elements or features will be oriented “on” other elements or features. Thus, the example terms “below” and “beneath” may include both upper and lower orientations. The devices may be additionally oriented (rotated 90 degrees or other orientations) and the spatial description terminology used herein is interpreted accordingly.

A term used herein is for the purpose of describing a particular implementation only and is not to be considered as limitation of the present disclosure. As used herein, “a”, “an” and “said/the” in the singular form are intended to include the plural forms as well, unless the context indicated clearly otherwise. It should also be understood that the terms at least one of “consists of” or “comprising”, when used in this description, identify the presence of at least one of stated features, integers, steps, operations, elements or components, but do not exclude the presence and addition of at least one of one or more other features, integers, steps, operations, elements, components or groups. As used herein, the term “at least one of” includes any and all combinations of the related listed items.

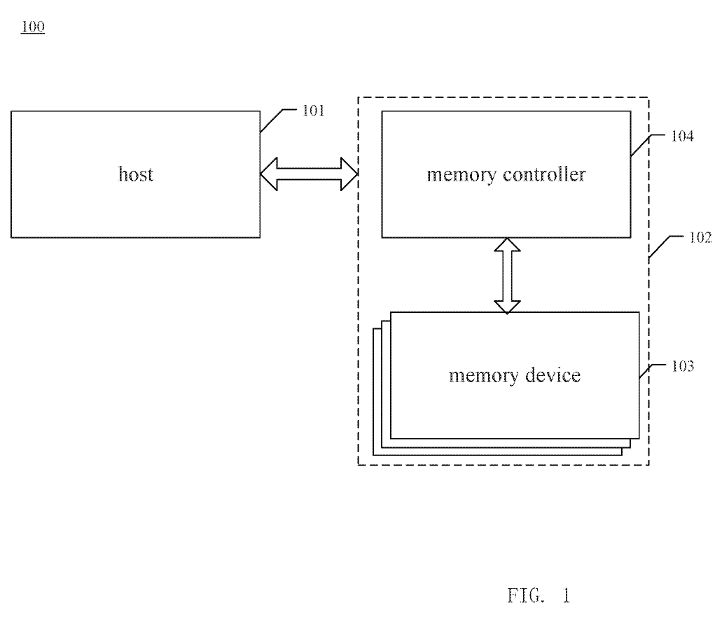

FIG. 1 is a schematic diagram of an example system having a memory system according to an implementation of the present disclosure. In an implementation of the present disclosure, the system 100 may include a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the system 100 may include a host 101 and a memory system 102, which may include one or more memory devices 103 and a memory controller 104. The host 101 may include a processor of an electronic device, for example, a central processing unit (CPU), or a system on a chip (SoC), for example, an application processor (AP). The host 101 may be configured to transmit data to the memory system 102 or receive data from the memory system 102.

In some implementations, the memory controller 104 is coupled to the memory device 103 and the host 101 and is configured to control the memory device 103. The memory controller 104 may manage data stored in the memory device 103 and communicate with the host 101. In some implementations, the memory controller 104 is designed to operate in a low duty cycle environment, such as in a secure digital card, compact flash card (CFC), universal serial bus (USB) flash drive, or to operate in other medium for use in electronic devices such as personal computers, digital cameras, mobile phones, or the like. In other implementations, the memory controller 104 is designed to operate in a high duty cycle environment, such as in a solid state disk or embedded multi-media card (eMMC).

In some implementations, the memory controller 104 and the one or more memory devices 103 may be integrated into various types of storage devices, for example, the memory system 102 may be implemented and packaged into different types of terminal electronics.

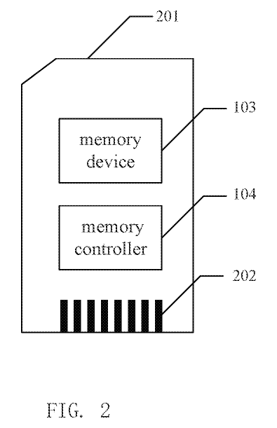

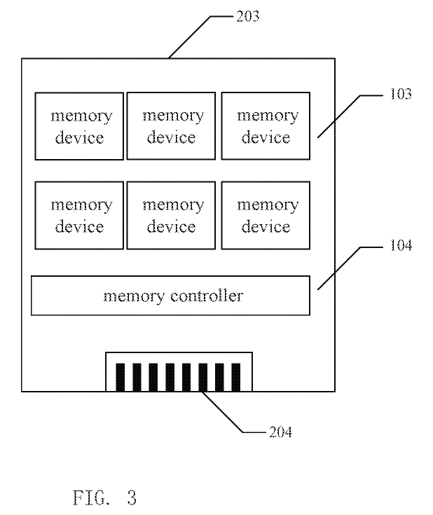

In one example as shown in FIG. 2, the memory controller 104 and the single memory device 103 may be integrated into the memory card 201. The memory card 201 may include one of a compact flash memory card, a smart media card (SMC), a memory stick (MS), a multi-media card (MMC), for example, an RS-MMC, an MMCmicro, an eMMC, or the like, a secure digital card, for example, a Mini SD card, a Micro SD card, an SDHC card, or the like, and a universal flash memory card. The memory card 201 may also include a memory card connector 202 that couples the memory card 201 with a host-side device (e.g., host 101 in FIG. 1). In another example as shown in FIG. 3, the memory controller 104 and a plurality of memory devices 103 may be integrated into SSD 203. SSD 203 may also include an SSD connector 204 that couples SSD 203 with a host-side device (e.g., host 101 in FIG. 1). In some implementations, at least one of the storage capacity or operating speed of SSD 203 is greater than at least one of the storage capacity or operating speed of memory card 201.

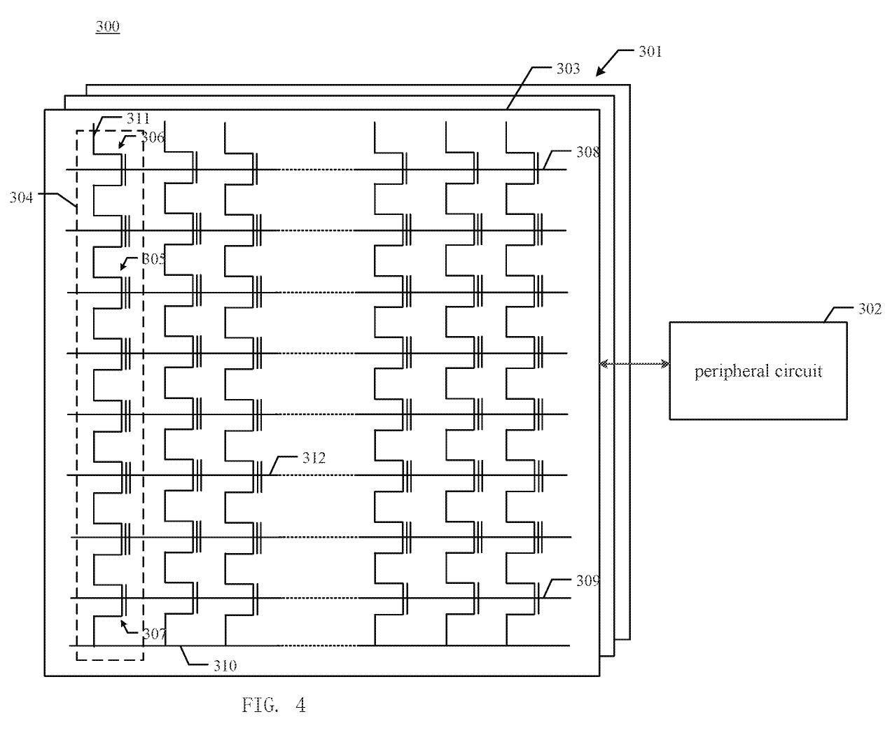

FIG. 4 is a schematic circuit diagram of an example memory device 300 including a peripheral circuit according to an implementation of the present disclosure. The memory device 300 may include an example of the memory device 103 in FIG. 1. The memory device 300 may include a storage array 301 and a peripheral circuit 302 coupled to the storage array 301. Taking the storage array 301 as a three-dimensional NAND type storage array as an example for description, where the memory cell 305 is a NAND memory cell, the memory cell 305 is provided in the form of an array of memory cell strings 304, and each memory cell string 304 extends vertically above a substrate (not shown). In some implementations, each memory cell string 304 includes a plurality of memory cells 305 coupled in series and stacked vertically. Each memory cell 305 may maintain a continuous analog value, e.g., voltage or charge, which depends on the number of electrons trapped within a region of memory cell 305. Each memory cell 305 can include either a floating gate type of memory cell including a floating-gate transistor or a charge trap type of memory cell including a charge-trap transistor.

In some implementations, each memory cell 305 is a single level cell (SLC) having two possible memory states and thus may store one bit of data. For example, the first memory state “0” may correspond to a first voltage range and the second memory state “1” may correspond to a second voltage range. In some implementations, each memory cell 305 is a multi-level cell capable of storing more than a single bit of data in four or more memory states, e.g., a multi-level cell (MLC) storing two bits per cell, a triple level cell (TLC) storing three bits per cell, or a quad-level cell (QLC) storing four bits per cell.

As shown in FIG. 4, each memory cell string 304 may include a bottom select transistor (BST) 307 at its source terminal and a top select transistor (TST) 306 at its drain terminal. The bottom select transistor 307 and the top select transistor 306 may be configured to activate the selected memory cell string 304 during read and programming operations. In some implementations, the sources of the memory cell strings 304 in the same memory block 303 may be coupled through a common source line (CSL) 310. For example, all the memory cell strings 304 in the same memory block 303 have an array common source (ACS). According to some implementations, the top select transistor 306 of each memory cell string 304 is coupled to a respective bit line (BL) 311 from which data can be read or written via an output bus (not shown). In some implementations, each memory cell string 304 is configured to be selected or deselected by at least one of: applying a select voltage (e.g., a voltage higher than a threshold voltage of the top select transistor 306) or a deselect voltage (e.g., 0V) to a top select gate (TSG) of the respective top select transistor 306 through one or more top select lines (TSL) 308 or applying a select voltage (e.g., a voltage higher than a threshold voltage of the bottom select transistor 307) or a deselect voltage (e.g., 0V) to a bottom select gate (BSG) of the respective bottom select transistor 307 through one or more bottom select lines (BSL) 309.

As shown in FIG. 4, the memory cell string 304 may be organized into a plurality of memory blocks 303, each of which may have a common source line 310. In some implementations, each memory block 303 is a basic data unit for an erase operation, e.g., all memory cells 305 on the same memory block 303 are erased simultaneously. To erase the memory cells 305 in the selected memory block, a common source line 310 coupled to the selected memory block and an unselected memory block in the same side as the selected memory block may be biased with an erase voltage. In some examples, erase operations may be performed at a half-memory block level, at a quarter-memory block level, or at a level with any suitable number of memory blocks or any suitable fraction of a memory block. Memory cells 305 of adjacent memory cell strings 304 may be coupled by word lines 312 that select which row of memory cells 305 is affected by read or programming operations.

In some implementations, the peripheral circuit 302 may include any suitable analog, digital, and mixed-signal circuit to enable operation of the storage array 301 by applying at least one of voltage signals or current signals to each of target memory cells 305 and sensing at least one of voltage signals or current signals from each of target memory cells 305 through the bit lines 311, the word lines 312, the common source lines 310, the bottom select lines 309, and the top select lines 308. The peripheral circuit 302 may include various types of peripheral circuits formed using metal-oxide-semiconductor technology.

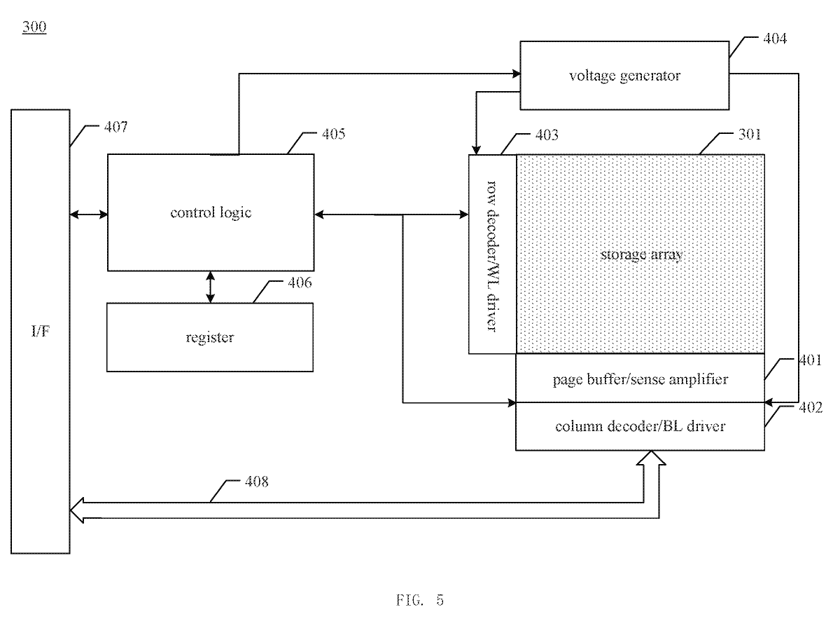

FIG. 5 shows some example peripheral circuits 302 including a page buffer / sensing amplifier 401, a column decoder / bit line driver 402, a row decoder / word line driver 403, a voltage generator 404, control logic 405, a register bank 406, a flash memory interface 407, and a data bus 408. In some examples, additional peripheral circuits not shown in FIG. 5 may also be included.

The page buffer / sensing amplifier 401 may be configured to read data from storage array 301 and program (write) data into the storage array 301 according to control signals from the control logic 405. In one example, the page buffer / sensing amplifier 401 may store a page of programming data (written data) to be programmed to the storage array 301. In another example, the page buffer / sensing amplifier 401 may perform a programming verification operation to ensure that data has been properly programmed into memory cells coupled to the selected word line. In yet another example, the page buffer / sensing amplifier 401 may also sense a low power signal from the bit line representing a data bit stored in the memory cell, and amplify a small voltage swing to an identifiable logic level in a read operation. The column decoder / bit line driver 402 may be configured to be controlled by the control logic 405 and select one or more memory cell strings by applying a bit line voltage generated from the voltage generator 404.

The row decoder / word line driver 403 may be configured to be controlled by the control logic 405 and select / deselect a memory block of the storage array 301 and select / deselect a word line of the memory block. The row decoder / word line driver 403 may also be configured to drive a word line using the word line voltage generated from the voltage generator 404. In some implementations, the row decoder / word line driver 403 may also select / deselect and drive the bottom select line and the top select line. As described in detail below, the row decoder / word line driver 403 is configured to perform a programming operation on memory cells coupled to the (one or more) selected word line(s). The voltage generator 404 may be configured to be controlled by the control logic 405 and generate word line voltages (e.g., reading voltages, programming voltages, passing voltages, local voltages, verifying voltages, etc.), bit line voltages, and source line voltages to be supplied to the storage array 301.

The control logic 405 may be coupled to each peripheral circuit described above and configured to control operation of each peripheral circuit. Register bank 406 may be coupled to control logic 405 and include status registers, command registers, and address registers for storing status information, command operation codes (OP codes), and command addresses for controlling operation of each peripheral circuit. The flash memory interface 407 may be coupled to the control logic 405 and act as a control buffer to buffer control commands received from a host-side device (not shown) and relay them to the control logic 405 and buffer status information received from the control logic 405 and relay it to a memory controller. The flash memory interface 407 may also be coupled to the column decoder / bit line driver 402 via the data bus 408, and act as a data I/O interface and a data buffer to buffer data and relay it to the storage array 301, or relay or buffer data from the storage array 301.

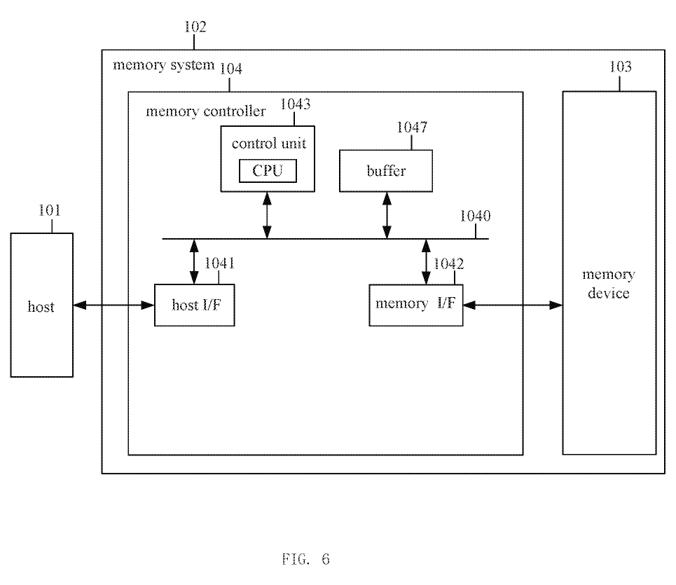

FIG. 6 is a schematic diagram of a system including a host and a memory system according to an implementation of the present disclosure. As shown in FIG. 6, the memory system 102 is connected to the host 101, where the memory system 102 may include a memory controller 104 and a memory device 103. The memory controller 104 is configured to control operations of the memory device 103, such as read, erase, and program; may also be configured to manage various functions regarding data stored in or to be stored in the memory device 103, including, but not limited to, bad block management, garbage collection, logical-to-physical address translation, wear leveling, etc.; and may be configured to process error checking and correction (ECC) regarding data read from or written into the memory device 103. Furthermore, the memory controller 104 may also perform any other suitable functions, such as formatting the memory device 103, or communicating with an external device (e.g., host 101 in FIG. 1) according to a particular communication protocol. Memory controller 104 and memory device 103 may be coupled in any suitable manner. The memory controller 104 may include a host interface (I/F) 1041, a memory interface (I/F) 1042, a control unit 1043, a buffer 1047, and a bus 1040. The host interface 1041 is a connection interface between the connection host 101 and the memory controller 104, and the host interface 1041 allows the host 101 and the memory controller 104 to communicate according to a specific protocol, transmit read and write requests, and perform other operations. The memory interface 1042 is a connection interface between the memory controller 104 and the memory device 103, and the memory interface 1042 is configured to implement data transmission between the memory controller 104 and the memory device 103. The control unit 1043 is configured to control the memory system 102 as a whole.

It can be understood that some of the flash memory cannot be overwritten, and therefore, as user data is continuously written, garbage (invalid data) will be generated in the flash space. Garbage collection refers to moving valid data on one or several memory blocks out and writing it to a new free memory block, and after valid data on these memory blocks are moved out, performing an erase operation on these memory blocks, so that these memory blocks can be used for writing new data.

In some examples, the control unit 1043 may include one or more units having a logical operation capability, for example, at least one of a central processing unit (CPU) or a microcontroller unit (MCU), or the like.

In some examples, the buffer 1047 is configured to buffer data, and may include a volatile memory device with a relatively fast read-write speed, such as at least one of a static random-access memory (SRAM) or a dynamic random access memory (DRAM).

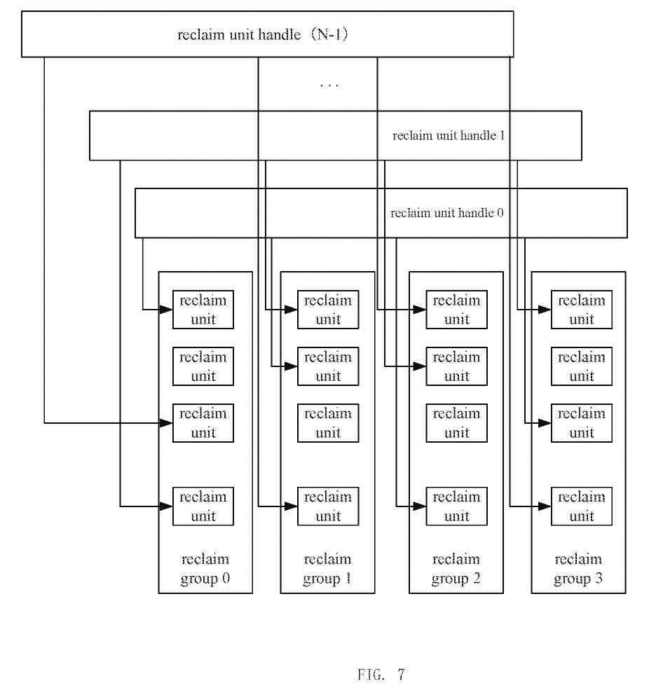

FIG. 7 is a schematic diagram of a memory system that supports a flexible data placement function. The memory system includes 4 reclaim groups (RGs) identified as a reclaim group 0 to a reclaim group 3. Each reclaim group may include one or more reclaim units (RUs). It may be understood that the number of the foregoing reclaim groups is only an example. The memory system may receive I / O commands from the host through the communication interface. The following takes an I / O command being a write command as an example for description. The write command may include the reclaim group information and information of a placement handle associated with the reclaim unit handle, which may enable the host to specify a reclaim group and a reclaim unit handle (RUH), and when the reclaim group information and the reclaim unit handle information are determined, the reclaim unit being pointed is also determined, and the reclaim unit may be configured to store the data that needs to be written. The memory system that supports flexible data placement functions has many advantages due to exposing the underlying logic of the device to the host, for example, the write amplification can approach 1, and the legacy application (APP) can be backwards compatible.

The following takes a memory system being SSD as an example for description. The memory system in the implementations of the present disclosure is not limited thereto.

In some implementations, the memory device includes a plurality of dies, where each die includes a plurality of memory blocks; and the memory controller is configured to: divide the plurality of dies into at least one reclaim group, where each reclaim group includes at least one die; and the reclaim unit includes memory blocks at a same location of the at least one die in the reclaim group.

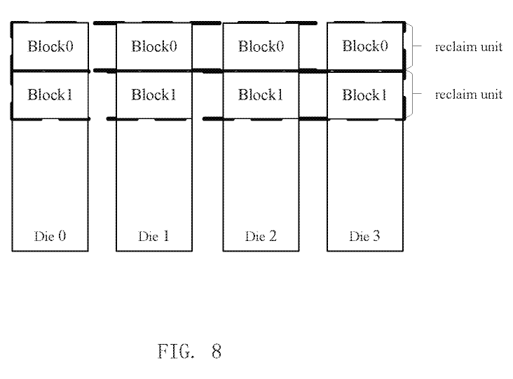

In some implementations, as shown in FIG. 8, the configuration of the reclaim group may include that the entire SSD is used as one reclaim group, the SSD includes a plurality of dies, and all dies are divided into one reclaim group. Each die includes a plurality of memory blocks. The plurality of memory blocks are numbered sequentially, for example, numbered from 0. In different dies, the memory blocks with the same numbering may constitute one super memory block, and one super memory block constitutes one reclaim unit. For example, Block0 of die 0, Block0 of die 1, Block0 of die 2, and Block0 of die 3 constitute one reclaim unit.

The memory blocks at the same location of the die herein may be understood as the memory blocks with the same numbering of the die.

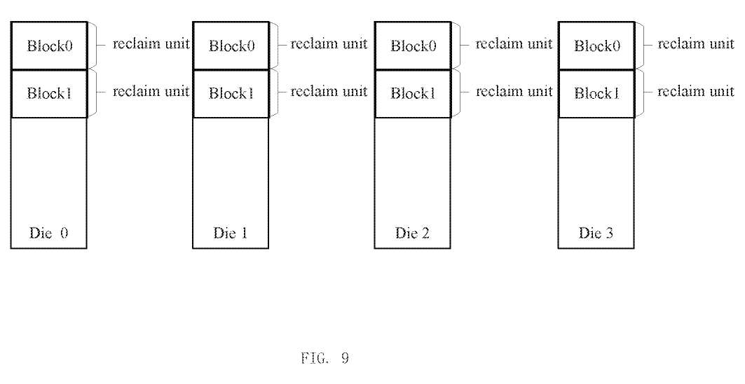

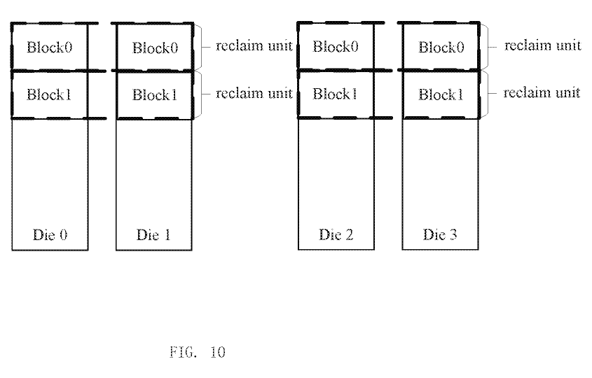

In some implementations, as shown in FIGS. 9 and FIG. 10, the configuration of the reclaim group may include that one or more dies may be used as one RG in the SSD, and it should be noted that in this scheme, the more dies does not mean all dies in the SSD. For example, if the total number of dies in the SSD is 4, one or two dies may be used as one RG. As shown in FIG. 9, if 1 die is used as one RG, one memory block in one die may be used as a reclaim unit. Block0 of die 0 constitutes one reclaim unit, and Block0 of die 1 also constitutes one reclaim unit. As shown in FIG. 10, if 2 dies are used as one RG, the memory blocks with the same numbering in the two dies may be used as one reclaim unit. Block0 of die 0 and Block0 of die 1 may constitute one reclaim unit. Block0 of die 2 and Block0 of die 3 may also constitute one reclaim unit.

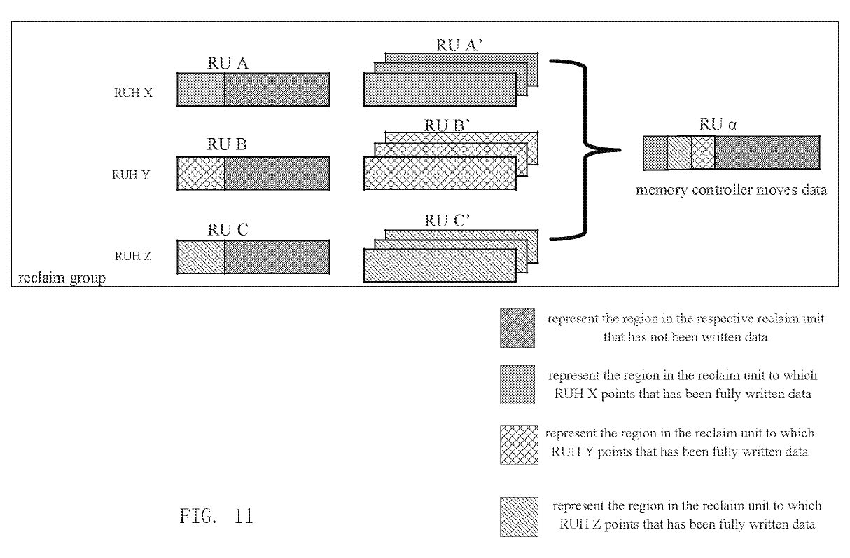

In some implementations, the type of reclaim unit handle includes an initially isolated type of reclaim unit handle. As shown in FIG. 11, the reclaim unit handle RUH X currently points to the reclaim unit RU A, the reclaim unit RU A’ is a reclaim unit to which data is once written by the reclaim unit handle RUH X, and the data currently stored in the reclaim unit RU A’ is still the data written by the reclaim unit handle RUH X, the reclaim unit RU A’ has been fully written with data, a part of the reclaim unit RU A is written with data, and another part of the reclaim unit RU A has not been written with data; the reclaim unit handle RUH Y currently points to the reclaim unit RU B, the reclaim unit RU B’ is a reclaim unit to which data is once written by the reclaim unit handle RUH Y, and the data currently stored in the reclaim unit RU B’ is still the data written by the reclaim unit handle RUH Y, the reclaim unit RU B’ has been fully written with data, a part of the reclaim unit RU B is written with data, and another part of the reclaim unit RU B has not been written with data; the reclaim unit handle RUH Z currently points to the reclaim unit RU C, the reclaim unit RU C’ is a reclaim unit to which data is once written by the reclaim unit handle RUH Z, and the data currently stored in the reclaim unit RU C’ is still the data written by the reclaim unit handle RUH Z, the reclaim unit RU C’ has been fully written with data, a part of the reclaim unit RU C is written with data, and another part of the reclaim unit RU C has not been written with data.

As shown in FIG. 11, when a garbage collection operation is performed on the data in the reclaim unit to which the RUH X points (including the reclaim unit RU A to which the reclaim unit handle is currently pointing and the reclaim unit RU A’ stored with the valid data once written by the reclaim unit handle), the data in the reclaim units RU B and the RU B’ to which the RUH Y points, and the data in the reclaim units RU C and the RU C’ to which the RUH Z points, the data written by the RUH X, the RUH Y, and the RUH Z is reclaimed into the same reclaim unit RU α. In this implementation, data of different types, different temperatures and different lifetimes can be respectively written by different reclaim unit handles in the data writing phase, so that better physical isolation can be achieved in the data writing phase, but in the garbage collection operation, data of different types, different temperatures and different lifetimes are moved together, so that physical isolation of the data is not good enough.

In the implementations of the present disclosure, different types of data may be understood as data of different applications.

In the implementations of the present disclosure, the data may be classified into 3 types according to the degree of cold and hot, including hot, warm, and cold. In some implementations, the temperature of the data may be related to the frequency of use of the data. In other implementations, the temperature of the data may be customized based on the type of the data. For example, a data block of a directory may be fixed into hot data. In other implementations, the temperature of the data may also be defined based on other data characteristics.

In the implementations of the present disclosure, a lifetime of data may be understood as a time from writing data to erasing data.

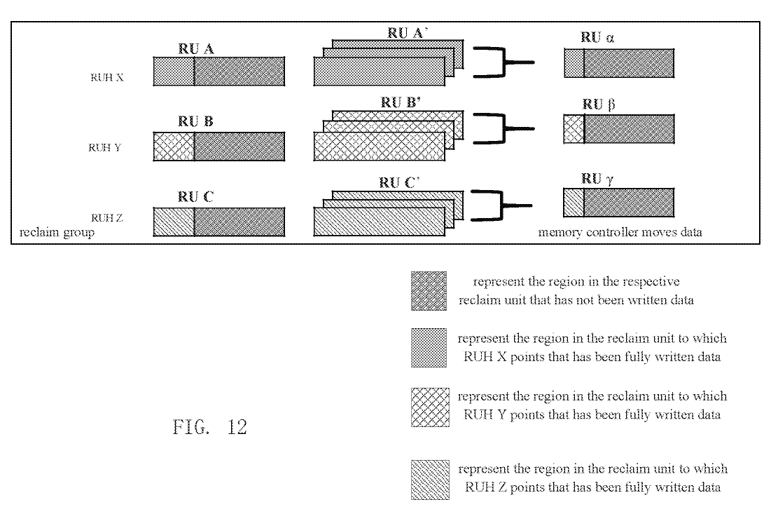

In some implementations, the type of reclaim unit handle includes a persistently isolated type of reclaim unit handle. As shown in FIG. 12, when a garbage collection operation is performed on the data in the reclaim unit to which the RUH X points (including the reclaim unit RU A to which the reclaim unit handle is currently pointing and the reclaim unit RU A’ storing the valid data once written by the reclaim unit handle), the data in the reclaim units RU B and the RU B’ to which the RUH Y points, and the data in the reclaim units RU C and the RU C’ to which the RUH Z points, the data written by the RUH X is reclaimed to the reclaim unit RU α, the data written by the RUH Y is reclaimed to the reclaim unit RU β, and the data written by the RUH Z is reclaimed to the reclaim unit RU γ. When the garbage collection operation is performed on the data in the reclaim unit to which the persistently isolated type of reclaim unit handle points, the reclaim unit for which the reclaim unit handle is used as the destination of garbage collection is preferentially used, or a new reclaim unit is requested, and the data in the reclaim units to which the different reclaim unit handles point are respectively reclaimed to different reclaim units. In this implementation, after a data writing phase or a subsequent garbage collection operation, the same type of data can be kept at the same reclaim unit handle all the time, so the physical isolation is better, and only valid data of the same type needs to be moved after multiple garbage collection operations. However, when the garbage collection operation is performed, the solution provided in this implementation requires the firmware to open more super memory blocks at the same time or open more memory blocks at the same time, which poses difficulty for firmware implementation.

An implementation of the present disclosure provides an electronic system, including a host and a memory system that supports a flexible data placement function; the memory system includes a memory controller and a memory device coupled to the memory controller; the host is configured to: send a first command; the first command carries information related to a relative lifetime of data written by a specified reclaim unit handle; the memory controller is configured to: receive the first command; and perform a garbage collection operation on the data written by the specified reclaim unit handle based on the information related to the relative lifetime.

In the implementations of the present disclosure, the first command sent by the host carries the information related to the relative lifetime of the data written by the specified reclaim unit handle, and after receiving the first command through the interface between the host and the memory controller, the control unit in the memory controller can perform a garbage collection operation on the data written by the specified reclaim unit handle based on the information related to the relative lifetime, so that the better data physical isolation is achieved without turning on excessive memory blocks at the same time, the implementation difficulty of the firmware is reduced, and the pressure of the garbage collection operation is reduced without hardware improvement.

It should be noted that the reclaim unit to which one reclaim unit handle points is not fixed, for example, after a reclaim unit to which a reclaim unit handle points is fully written, the reclaim unit handle may point to other free reclaim units in the reclaim group to which the fully written reclaim unit belongs. However, for one reclaim group, one reclaim unit handle only points to one reclaim unit in the reclaim group at a time, and does not point to two reclaim units in the reclaim group at the same time.

In the implementations of the present disclosure, the data written by the specified reclaim unit handle includes the data written by the reclaim unit to which the current reclaim unit handle points, and the data written by the reclaim unit that stores the valid data once written by the reclaim unit handle.

In the implementations of the present disclosure, the information related to the relative lifetime of the data written by the specified reclaim unit handle includes the value of the relative lifetime of the data written by the specified reclaim unit handle.

In some implementations, the value of the relative lifetime of the data written by the reclaim unit handle ranges from 1 to 63.

It should be noted that the scope of the value of the relative lifetime given in the foregoing implementation is merely an example, and is not intended to limit the scope of the relative lifetime in the implementations of the present disclosure.

In the implementations of the present disclosure, the value of the relative lifetime is not the actual value of the lifetime, but the relative value of the lifetime, and a larger relative lifetime represents a longer lifetime, and a smaller relative lifetime represents a shorter lifetime. For example, when the value of the relative lifetime ranges from 1 to 63, the relative lifetime of 1 represents the shortest lifetime, and the relative lifetime of 63 represents the longest lifetime. The actual lifetime of the data may be understood as the time elapsed since the data is written until the data is erased.

In some examples, the host may select a corresponding relative lifetime according to its own requirements and the service scenario, may select a range in the overall relative lifetime range, for example, may use the relative lifetime range of 1-10, or may also use the overall relative lifetime of 1-63.

In some implementations, the value of the relative lifetime of each data written by the reclaim unit handle corresponds to the actual lifetime range of the data written by the reclaim unit handle.

For example, when the value of the relative lifetime of the data written by the reclaim unit handle is 1, the corresponding actual lifetime range of the data written by the reclaim unit handle is 1 day to 2 days; and when the value of the relative lifetime of the data written by the reclaim unit handle is 63, the corresponding actual lifetime range of the data written by the reclaim unit handle is 63 days to 126 days.

The corresponding actual lifetime range of the data written by the reclaim unit handle under the value of the relative lifetime of the data written by the reclaim unit handle given in the foregoing implementation is merely an example, and is not intended to limit the corresponding actual lifetime range of the data written by the reclaim unit handle in the implementations of the present disclosure.

In some implementations, when the value of the relative lifetime of the data written by the reclaim unit handle is 1, the value of the actual lifetime of the data written by the reclaim unit handle is 1 day; and when the value of the relative lifetime of the data written by the reclaim unit handle is 63, the value of the actual lifetime of the data written by the reclaim unit handle is 63 days.

In some implementations, when the value of the relative lifetime of the data written by the reclaim unit handle is 1, the value of the actual lifetime of the data written by the reclaim unit handle is 2 days; and when the value of the relative lifetime of the data written by the reclaim unit handle is 63, the value of the actual lifetime of the data written by the reclaim unit handle is 126 days.

It should be noted that the actual lifetime under the relative lifetime in the implementations of the present disclosure is merely an example, and is not intended to limit the value of the actual lifetime under the relative lifetime in the implementations of the present disclosure.

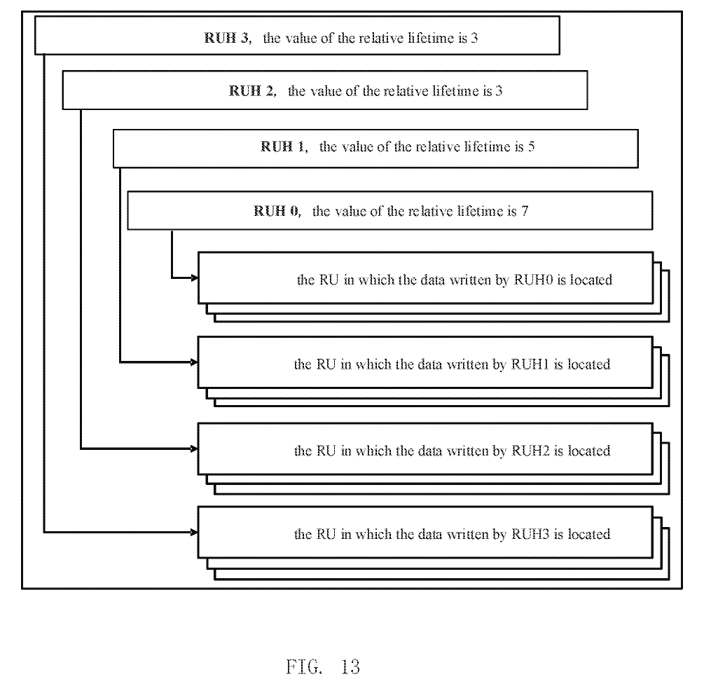

In some implementations, the values of the relative lifetimes of the data written by the same reclaim unit handle may be considered equal, for example, different reclaim unit handles have respective corresponding lifetimes. As shown in FIG. 13, the value of the relative lifetime corresponding to the reclaim unit handle 3 (RUH3) is 3, the reclaim unit handle 3 points to a plurality of RUs, the plurality of RUs being pointed here include a reclaim unit storing valid data once written by the reclaim unit handle 3 and a reclaim unit to which the reclaim unit handle 3 is currently pointing, and the value of the relative lifetime of the data in the plurality of RUs may be considered as 3; the value of the relative lifetime corresponding to the reclaim unit handle 1 (RUH1) is 5, the reclaim unit handle 1 points to a plurality of RUs, the plurality of RUs being pointed here include a reclaim unit storing valid data once written by the reclaim unit handle 1 and a reclaim unit to which the reclaim unit handle 1 is currently pointing, and the value of the relative lifetime of the data in the plurality of RUs may be considered as 5; other reclaim unit handles are similar, and details are not described herein again for brevity.

In some implementations, the memory controller is further configured to: perform a garbage collection operation on the data written by the different reclaim unit handles based on the information related to the relative lifetime, so as to reclaim the data written by the first reclaim unit handle and the data written by the second reclaim unit handle into the same first reclaim unit, and reclaim the data written by the third reclaim unit handle into the second reclaim unit; where the value of the relative lifetime of the data written by the third reclaim unit handle is different from the values of the relative lifetimes of the data written by the first reclaim unit handle and the data written by the second reclaim unit handle.

It may be understood that, in the implementations of the present disclosure, the data written by the first reclaim unit handle and the data written by the second reclaim unit handle are reclaimed to the same first reclaim unit. The first reclaim unit may include a reclaim unit for which the first reclaim unit handle and the second reclaim unit handle have been used as garbage collection destinations, or may include a new reclaim unit being requested. Data written by the third reclaim unit handle will be reclaimed to the second reclaim unit. The second reclaim unit and the first reclaim unit are different reclaim units. The second reclaim unit may include a reclaim unit for which the third reclaim unit handle has been used as the garbage collection destination, or may be a new reclaim unit being requested. In the implementations of the present disclosure, the value of the relative lifetime of the data written by the third reclaim unit handle is different from the values of the relative lifetimes of the data written by the first reclaim unit handle and the data written by the second reclaim unit handle, and the value of the relative lifetime of the data written by the first reclaim unit handle and the value of the relative lifetime of the data written by the second reclaim unit handle may be the same or different, but when the value of the relative lifetime of the data written by the first reclaim unit handle and the value of the relative lifetime of the data written by the second reclaim unit handle are different, the value of the relative lifetime of the data written by the first reclaim unit handle and the value of the relative lifetime of the data written by the second reclaim unit handle are close.

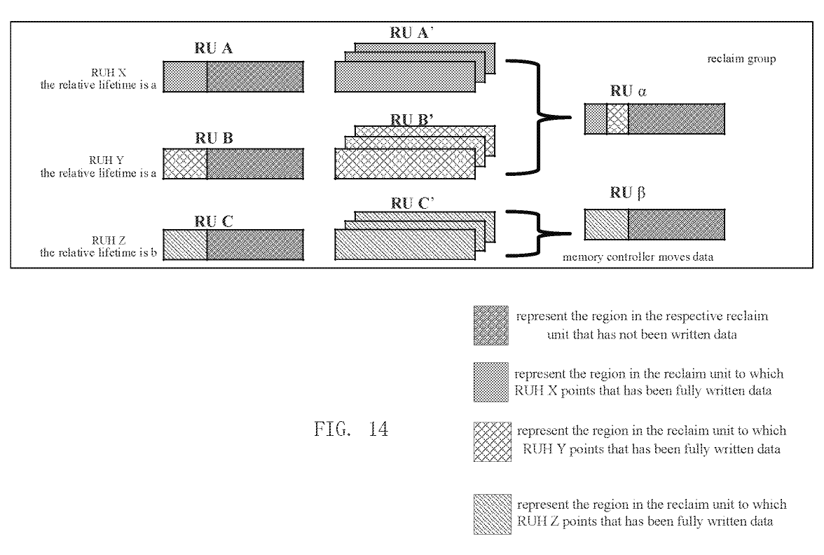

For example, as shown in FIG. 14, the type of the reclaim unit handle includes a conditionally isolated type of reclaim unit handle. As shown in FIG. 14, the relative lifetimes of the data written by the reclaim unit handle RUH X and the RUH Y are the same and both are a, and the relative lifetime of the data written by the reclaim unit handle RUH Z is b, a and b are not equal. When the garbage collection operation is performed on the data in the reclaim units to which the RUH X, RUH Y, and RUH Z point (including the reclaim units RU A’, RU B’, and RU C’ storing the valid data once written by the reclaim unit handle and the reclaim units RUA, RUB, and RUC to which the reclaim unit handle is currently pointing), the data written by the RUH X and the data written by the RUH Y are both reclaimed to the reclaim unit RU α, and the data written by the RUH Z is reclaimed to the reclaim unit RU β.

In some implementations, the ratio of the absolute value of the difference between the value of the relative lifetime of the data written by the first reclaim unit handle and the value of the relative lifetime of the data written by the second reclaim unit handle to the value of the relative lifetime of the data written by the first reclaim unit handle is less than or equal to a preset value.

Here, the data written by the first reclaim unit handle includes the data in the reclaim unit to which the first reclaim unit handle is currently pointing and the data in the reclaim unit that stores the valid data once written by the first reclaim unit handle. The data written by the second reclaim unit handle includes the data in the reclaim unit to which the second reclaim unit handle is currently pointing and the data in the reclaim unit that stores the valid data once written by the second reclaim unit handle. The data written by the third reclaim unit handle includes the data in the reclaim unit to which the third reclaim unit handle is currently pointing and the data in the reclaim unit that stores the valid data once written by the third reclaim unit handle.

Here, the ratio of the absolute value of the difference between the value of the relative lifetime of the data written by the first reclaim unit handle and the value of the relative lifetime of the data written by the second reclaim unit handle to the value of the relative lifetime of the data written by the first reclaim unit handle being less than or equal to a preset value may be understood as the value of the relative lifetime of the data written by the first reclaim unit handle being the same as or close to the value of the relative lifetime of the data written by the second reclaim unit handle.

In some implementations, the ratio of the difference between the value of the relative lifetime of the data written by the first reclaim unit handle / second reclaim unit handle and the value of the relative lifetime of the data written by the third reclaim unit handle to the value of the relative lifetime of the data written by the first reclaim unit handle / second reclaim unit handle is greater than a preset value.

Here, the ratio of the difference between the value of the relative lifetime of the data written by the first reclaim unit handle / second reclaim unit handle and the value of the relative lifetime of the data written by the third reclaim unit handle to the value of the relative lifetime of the data written by the first reclaim unit handle / second reclaim unit handle being greater than a preset value may be understood as the value of the relative lifetime of the data written by the first reclaim unit handle is quite different from the value of the relative lifetime of the data written by the second reclaim unit handle.

According to the implementations of the present disclosure, when the garbage collection operation is performed, the data written by the reclaim unit handles whose values of the relative lifetimes are the same or close are reclaimed to the same reclaim unit, and the data written by the different reclaim unit handles whose values of the relative lifetimes are quite different are reclaimed to different reclaim units, so that when the garbage collection operation is performed, the better data physical isolation is achieved without turning on excessive memory blocks or super memory blocks at the same time, the garbage collection pressure can be reduced, and the performance is improved.

In some implementations, the range of the preset value is less than or equal to 10%.

It should be noted that the range of the preset value according to the foregoing implementation is merely an example, and is not intended to limit the range of the preset value in the implementations of the present disclosure. The range of the preset value may be correspondingly adjusted according to the comprehensive consideration for both data physical isolation and garbage collection pressure.

In some implementations, the preset value is 0.

It may be understood that, when the preset value is 0, it represents that the relative lifetime of the data written by the first reclaim unit handle is equal to the relative lifetime of the data written by the second reclaim unit handle. When the garbage collection operation is performed, data with the same relative lifetime is reclaimed to the same reclaim unit, so that better data physical isolation can be achieved.

In some implementations, data written by different reclaim unit handles is reclaimed in the first reclaim unit, and data written by the same reclaim unit handle is reclaimed in the second reclaim unit.

In some implementations, the first command instructs to create a namespace, or the first command instructs to manage input / output behavior.

It may be understood that the first command may include a command to instruct to create the command space, or may include a command to instruct to manage the input / output behavior. However, the implementations of the present disclosure are not limited thereto, and in the implementations of the present disclosure, the first command may also include another command, and the first command instructs to send the information related to the relative lifetime of the data written by the specified reclaim unit handle to the memory controller.

In some implementations, the memory controller is configured to: create a namespace in response to the first command; specify at least one reclaim unit handle for the namespace and establish correspondence between the specified reclaim unit handle and a placement handle; and specify one reclaim unit in the reclaim group for the specified reclaim unit handle.

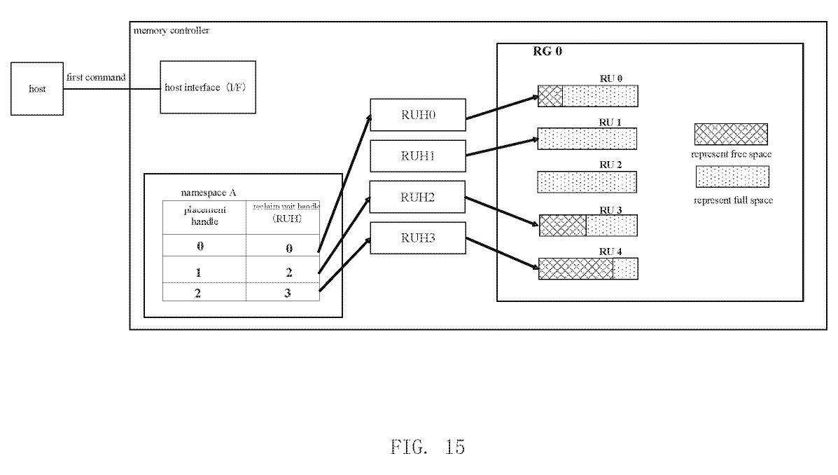

As shown in FIG. 15, the host sends a first command, and the control unit in the memory controller receives the first command through the host interface (I / F); and the control unit in the memory controller creates a namespace A in response to the first command, and specifies RUH0, RUH2, and RUH3 for the namespace A. The correspondence between the specified reclaim unit handle and the placement handle is that: RUH0 corresponds to the placement handle 0, RUH2 corresponds to the placement handle 1, and RUH3 corresponds to the placement handle 2. The reclaim unit in the reclaim group 0 (RG0) specified by RUH0 is RU0, the reclaim unit in the reclaim group 0 specified by RUH1 is RU1, the reclaim unit in the reclaim group 0 specified by RUH2 is RU3, and the reclaim unit in the reclaim group 0 specified by RUH3 is RU4.

In some implementations, the host is configured to: send a third command; the third command carries a placement handle identifier and a reclaim group identifier; and the memory controller is configured to: determine a target reclaim unit based on the placement handle identifier and the reclaim group identifier; and perform a write operation on the target reclaim unit in response to the third command.

In the implementations of the present disclosure, the host sends the third command to the memory controller, where the third command may include a write command. The third command carries the placement handle identifier and the reclaim group identifier, the target placement handle that needs to be written can be determined by the placement handle identifier, the target reclaim unit handle corresponding to the target placement handle can be further confirmed by the correspondence between the placement handle and the reclaim unit handle, the target reclaim group can be determined according to the reclaim group identifier, and the target reclaim unit can be determined according to the target reclaim group, the target reclaim unit handle and the reclaim unit to which the target reclaim unit handle is currently pointing. After determining the target reclaim unit, the memory controller performs a write operation on the target reclaim unit in response to the third command.

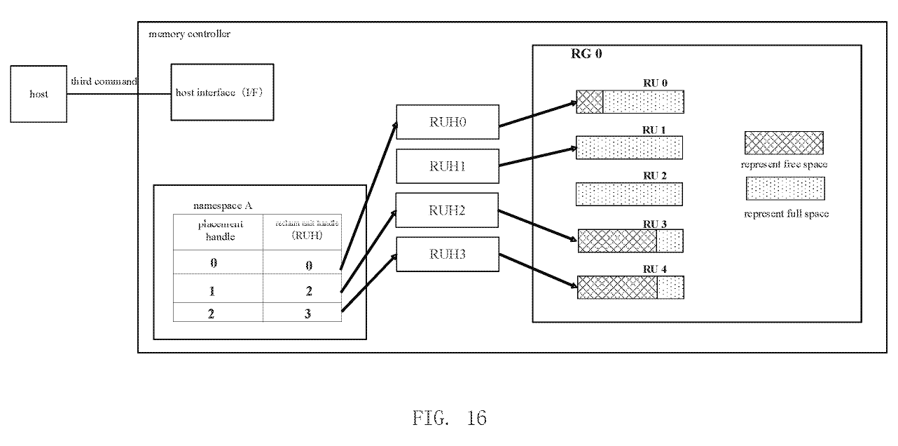

Specifically, as shown in FIG. 16, the host sends a third command related to the namespace A to the control unit in the memory controller through the host interface (I / F), where the third command may include a write command, the third command carries the identifiers of the placement handle 1 and the reclaim group 0 (RG0), a reclaim unit handle 2 corresponding to the placement handle 1 is determined according to the relationship between the placement handle and the reclaim unit handle, and the reclaim unit 3 in the reclaim group 0 is determined as target reclaim unit according to the reclaim unit handle 2 currently pointing to the reclaim unit 3 (RU3) in the reclaim group 0; and the control unit in the memory controller writes the data that needs to be written into the reclaim unit 3 in the reclaim group 0 in response to the third command. After the reclaim unit 3 in the reclaim group 0 is fully written, the reclaim unit handle 2 may also point to a new reclaim unit in the reclaim group 0, for example, the reclaim unit 2 (RU2).

In the implementations of the present disclosure, the information related to the relative lifetime of the data written by the specified reclaim unit handle may be carried by the first command.

In some implementations, the information related to the lifetime corresponding to the respective one of all the reclaim unit handles may be carried by one first command.

In some other implementations, the information related to the lifetime corresponding to the respective one of all the reclaim unit handles may be carried by a plurality of first commands, and each first command carries information related to the lifetime corresponding to the respective one of some of the reclaim unit handles. For example, if the first command shown in FIG. 15 is associated with the namespace A, and the namespace A specifies RUH0, RUH2, and RUH3, the first command carries information related to the relative lifetimes corresponding to RUH0, RUH2, and RUH3. Other first command may be associated with other namespaces, which may specify other reclaim unit handle other than RUH0, RUH2, and RUH3, then the other first command carry information related to the relative lifetime corresponding to the other reclaim unit handle.

When the first command instructs to manage the input / output behavior, a new management operation may be specified in the command format of the first command, for example, an operation for updating the relative lifetime corresponding to the reclaim unit handle (RUH Relative Lifetime Update) may be newly defined to carry the relative lifetime corresponding to the reclaim unit handle, for example, the information of the relative lifetime may be placed at a vendor specific without affecting compatibility.

When the first command instructs to create the namespace, the information related to the relative lifetime may be placed in the space reserved for the placement handle list in the command format of the first command without affecting compatibility.

It should be noted that the foregoing manner of carrying the relative lifetime in the first command is merely an example, and is not intended to limit the present disclosure, and the manner of carrying the relative lifetime in the first command may also include other possible manners.

In some implementations, the host is configured to: send a second command based on a change in the relative lifetime of the data written by the specified reclaim unit handle; the second command carries the updated information related to the relative lifetime of the data written by the specified reclaim unit handle; and the memory controller is configured to: receive the second command; and perform a garbage collection operation on the data written by the specified reclaim unit handle based on the information related to the relative lifetime carried in the second command.

In the implementations of the present disclosure, the second command may include a command similar to the first command. The second command instructs to create the namespace, or the second command instructs to manage the input / output behavior, or the second command may also include other command. When the relative lifetime of the data written by the specified reclaim unit handle changes, the host may send a second command to the memory controller, where the second command carries the updated information related to the relative lifetime of the data written by the specified reclaim unit, and after receiving the updated information related to the relative lifetime of the data written by the specified reclaim unit carried in the second command, the memory controller performs the garbage collection operation on the data written by the specified reclaim unit handle based on the updated information related to the relative lifetime of the data written by the specified reclaim unit.

In some implementations, the host is configured to: send a fourth command; the fourth command instructs to obtain the type of the reclaim unit handle; and send the first command carrying the information related to the relative lifetime of the data written by the reclaim unit handle based on the type of the reclaim unit handle being the first type.

In the implementations of the present disclosure, the host may send the fourth command to the memory controller to obtain the type of the reclaim unit handle, where the fourth command may include a query command. And sending the first command carrying the information related to the relative lifetime of the data written by the reclaim unit handle based on the type of the reclaim unit handle being the first type; and not sending the first command carrying the information related to the relative lifetime of the data written by the reclaim unit handle based on the type of the reclaim unit handle being the second type. For example, the host will send the fourth command, query the type of the reclaim unit handle of the memory system connected to the host in advance, and different garbage collection strategies may be used for the data written by different types of reclaim unit handles, thereby achieving the compatibility of the garbage collection operation on the data written by different types of reclaim unit handles.

The first type herein includes the conditionally isolated type mentioned above, and the second type herein comprises the initially isolated type and the persistently isolated type mentioned above.

It should be noted that the implementations of the present disclosure may be used in a conventional data center and a server, or may be used in a cloud storage system.

In the foregoing implementations, the electronic system may be the system 100 shown in FIG. 1, the structure and composition of the memory system may refer to the detailed description of FIGS. 1 to FIG. 6, the memory device herein may be the memory device 103 shown in FIGS. 1 to FIG. 6, and the memory controller herein may be the memory controller 104 shown in FIGS. 1, FIG. 2, FIG. 3, and FIG. 6, and details are not described herein again for brevity.

Based on the foregoing electronic system, an implementation of the present disclosure further provides a memory controller, configured to: receive a first command, where the first command carries information related to a relative lifetime of data written by a specified reclaim unit handle; and perform a garbage collection operation on the data written by the specified reclaim unit handle based on the information related to the relative lifetime.

Based on the foregoing electronic system, an implementation of the present disclosure further provides a host, configured to: send a first command; where the first command carries information related to a relative lifetime of data written by a specified reclaim unit handle.

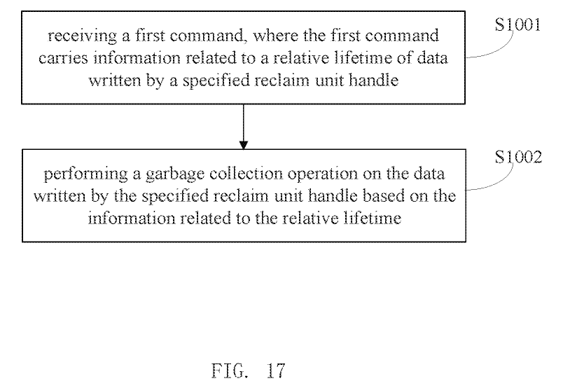

Based on the foregoing electronic system, an implementation of the present disclosure further provides an method of operating a memory system, where the memory system supports a flexible data placement function, as shown in FIG. 17, the method includes: operation S1001: receiving a first command, where the first command carries information related to a relative lifetime of data written by a specified reclaim unit handle; and operation S1002: performing a garbage collection operation on the data written by the specified reclaim unit handle based on the information related to the relative lifetime.

In some implementations, the first command instructs to create a namespace, or the first command instructs to manage input / output behavior.

In some implementations, the performing the garbage collection operation on the data written by the specified reclaim unit handle based on the information related to the relative lifetime carried in the first command includes: performing a garbage collection operation on data written by different reclaim unit handles based on the information related to the relative lifetime, so as to reclaim data written by a first reclaim unit handle and data written by a second reclaim unit handle into a same first reclaim unit, and reclaim data written by a third reclaim unit handle into a second reclaim unit; where a value of a relative lifetime of the data written by the third reclaim unit handle is different from values of relative lifetimes of the data written by the first reclaim unit handle and the data written by the second reclaim unit handle.

In some implementations, a ratio of an absolute value of a difference between the value of the relative lifetime of the data written by the first reclaim unit handle and the value of the relative lifetime of the data written by the second reclaim unit handle to the value of the relative lifetime of the data written by the first reclaim unit handle is less than or equal to a preset value.

In some implementations, a ratio of a difference between the value of the relative lifetime of the data written by the first reclaim unit handle / second reclaim unit handle and the value of the relative lifetime of the data written by the third reclaim unit handle to the value of the relative lifetime of the data written by the first reclaim unit handle / second reclaim unit handle is greater than a preset value.

In some implementations, a range of the preset value is less than or equal to 10%.

In some implementations, the preset value is 0.

In some implementations, data written by different reclaim unit handles is reclaimed in a first reclaim unit, and data written by the same reclaim unit handle is reclaimed in a second reclaim unit.

In some implementations, a range of the value of the relative lifetime of the data written by the reclaim unit handle is from 1 to 63.

In some implementations, when the value of the relative lifetime of the data written by the reclaim unit handle is 1, a value of an actual lifetime of the data written by the reclaim unit handle is 1 day; and when the value of the relative lifetime of the data written by the reclaim unit handle is 63, the value of the actual lifetime of the data written by the reclaim unit handle is 63 days.

In some implementations, the method further includes: creating a namespace in response to the first command; specifying at least one reclaim unit handle for the namespace and establishing correspondence between the specified reclaim unit handle and a placement handle; specifying one reclaim unit in the reclaim group for the specified reclaim unit handle; determining a target reclaim unit based on a placement handle identifier and a reclaim group identifier carried in a third command; and perform a write operation on the target reclaim unit in response to the third command.

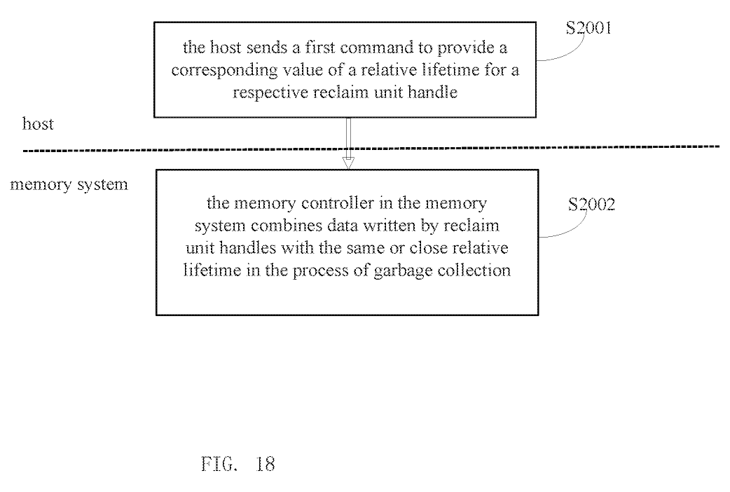

FIG. 18 is a schematic diagram of a process of a garbage collection operation according to an implementation of the present disclosure. As shown in FIG. 18, operation S2001: the host sends a first command to provide a corresponding value of a relative lifetime for a respective reclaim unit handle; and operation S2002, the memory controller in the memory system combines data written by reclaim unit handles with the same or close relative lifetime in the process of garbage collection.

The foregoing relevant details about the method of operating the memory system are described in detail in the foregoing descriptions about the electronic system, and details are not described herein again for brevity.

Based on the foregoing method of operating the memory system, an implementation of the present disclosure further provides a memory system, where the memory system supports a flexible data placement function, and the memory system includes a memory controller and a memory device coupled to the memory controller; and the memory controller is configured to: receive a first command; the first command carries information related to a relative life cycle of data written by a specified reclaim unit handle; and perform a garbage collection operation on the data written by the specified reclaim unit handle based on the information related to the relative life cycle.

In some implementations, the memory device includes, but is not limited to, a NAND-type memory device.

In some implementations, the first command instructs to create a namespace, or the first command instructs to manage input / output behavior.

In some implementations, the memory controller is configured to: perform a garbage collection operation on data written by different reclaim unit handles based on the information related to the relative lifetime, so as to reclaim data written by a first reclaim unit handle and data written by a second reclaim unit handle into a same first reclaim unit, and reclaim data written by a third reclaim unit handle into a second reclaim unit; where a value of a relative lifetime of the data written by the third reclaim unit handle is different from values of relative lifetimes of the data written by the first reclaim unit handle and the data written by the second reclaim unit handle.

In some implementations, a ratio of an absolute value of a difference between the value of the relative lifetime of the data written by the first reclaim unit handle and the value of the relative lifetime of the data written by the second reclaim unit handle to the value of the relative lifetime of the data written by the first reclaim unit handle is less than or equal to a preset value.

In some implementations, a ratio of a difference between the value of the relative lifetime of the data written by the first reclaim unit handle / second reclaim unit handle and the value of the relative lifetime of the data written by the third reclaim unit handle to the value of the relative lifetime of the data written by the first reclaim unit handle / second reclaim unit handle is greater than a preset value.

In some implementations, a range of the preset value is less than or equal to 10%.

In some implementations, the preset value is 0.

In some implementations, data written by different reclaim unit handles is reclaimed in a first reclaim unit, and data written by the same reclaim unit handle is reclaimed in a second reclaim unit.

In some implementations, a range of the value of the relative lifetime of the data written by the reclaim unit handle is from 1 to 63.

In some implementations, the memory device includes a plurality of dies, where each die includes a plurality of memory blocks; and the memory controller further is configured to: divide the plurality of dies into at least one reclaim group, where each reclaim group includes at least one die; and the reclaim unit includes memory blocks at a same location of the at least one die in the reclaim group.

The foregoing relevant details about the method of operating the memory system are described in detail in the foregoing descriptions about the electronic system, and details are not described herein again for brevity.

The structure and composition of the memory system herein may be described in detail with reference to FIGS. 1 to FIG. 6, and details are not described herein again for brevity. The memory device herein may be the memory device 103 shown in FIGS. 1 to FIG. 6, and the memory controller herein may be the memory controller 104 shown in FIGS. 1, FIG. 2, FIG. 3, and, FIG. 6. Further details about the memory system have been described in detail above, and are not described herein for brevity.

Based on the foregoing method of operating the memory system, an implementation of the present disclosure further provides a computer-readable storage medium storing computer programs, where the computer programs, when executed by a processor, implement the method of operating the memory system according to any one of the foregoing implementations.

Herein, all or part of the processes in the method of operating the memory system in the foregoing examples may be completed by using computer programs for instructing related hardware, and the programs may be stored in a computer-readable storage medium, and the programs, when executed, may include a process of the implementations of the foregoing methods. The storage medium may include a ferromagnetic random access memory (FRAM), a read only memory (ROM), a programmable read-only memory (PROM), an erasable programmable read-only memory (EPROM), an electrically erasable programmable read-only memory (EEPROM), a flash memory, a magnetic surface memory, an optical disk, or a compact disc read-only memory (CD-ROM), or the like; and the storage medium may further include a combination of the foregoing types of memories.

The features disclosed in the several device examples according to the present disclosure may be arbitrarily combined without conflict, to obtain a new device implementations.

The methods disclosed in the several method implementations according to the present disclosure may be arbitrarily combined without conflict, to obtain a new method implementations.

The above descriptions are only specific implementations of the present disclosure, but the protection scope of the present disclosure is not limited thereto, and changes or replacements that may be easily conceived by any person skilled in the art within the technical scope of the present disclosure should be covered within the protection scope of the present disclosure.

What is claimed is:

1. An electronic system, comprising:
a host configured to send a first command, wherein the first command carries information related to a relative lifetime of data written by a specified reclaim unit handle; and
a memory system supporting a flexible data placement function and comprising:
a memory device; and
a memory controller coupled to the memory device and configured to:
receive the first command; and
perform a garbage collection operation on the data written by the specified reclaim unit handle based on the information related to the relative lifetime.

2. The electronic system of claim 1, wherein the first command instructs to create a namespace, or wherein the first command instructs to manage input / output behavior.

3. The electronic system of claim 1, wherein the memory controller is further configured to perform the garbage collection operation on data written by different reclaim unit handles based on the information related to the relative lifetime, so as to reclaim data written by a first reclaim unit handle and data written by a second reclaim unit handle into a same first reclaim unit and reclaim data written by a third reclaim unit handle into a second reclaim unit, and wherein a value of a relative lifetime of the data written by the third reclaim unit handle is different from values of relative lifetimes of the data written by the first reclaim unit handle and the data written by the second reclaim unit handle.

4. The electronic system of claim 3, wherein a ratio of an absolute value of a difference between the value of the relative lifetime of the data written by the first reclaim unit handle and the value of the relative lifetime of the data written by the second reclaim unit handle to the value of the relative lifetime of the data written by the first reclaim unit handle is less than or equal to a preset value.

5. The electronic system of claim 4, wherein a ratio of a difference between the value of the relative lifetime of the data written by the first reclaim unit handle or the second reclaim unit handle and the value of the relative lifetime of the data written by the third reclaim unit handle to the value of the relative lifetime of the data written by the first reclaim unit handle or the second reclaim unit handle is greater than the preset value.

6. The electronic system of claim 4, wherein a range of the preset value is less than or equal to 10%.

7. The electronic system of claim 5, wherein the preset value is 0.

8. The electronic system of claim 3, wherein data written by different reclaim unit handles is reclaimed in the first reclaim unit, and wherein data written by the same reclaim unit handle is reclaimed in the second reclaim unit.

9. The electronic system of claim 1, wherein a range of a value of the relative lifetime of the data written by the reclaim unit handle is from 1 to 63.

10. The electronic system of claim 9, wherein each of values of relative lifetimes of data written by the reclaim unit handle corresponds to a range of actual lifetime of data written by the reclaim unit handle.

11. The electronic system of claim 1, wherein:
the host is configured to send a second command based on a change in the relative lifetime of the data written by the specified reclaim unit handle, wherein the second command carries updated information related to the relative lifetime of the data written by the specified reclaim unit handle; and
the memory controller is configured to:
receive the second command; and
perform the garbage collection operation on the data written by the specified reclaim unit handle based on the information related to the relative lifetime carried in the second command.

12. The electronic system of claim 1, wherein the memory device comprises a plurality of dies, and each of the dies comprises a plurality of memory blocks, and the memory controller further is configured to divide the plurality of dies into at least one reclaim group, wherein each reclaim group comprises at least one die, and wherein the reclaim unit comprises memory blocks at a same location of the at least one die in the reclaim group.

13. The electronic system of claim 12, wherein the memory controller is configured to:
create a namespace in response to the first command;
specify at least one reclaim unit handle for the namespace and establish correspondence between the specified reclaim unit handle and a placement handle; and
specify one reclaim unit in the reclaim group for the specified reclaim unit handle.

14. The electronic system of claim 13, wherein:
the host is configured to send a third command, wherein the third command carries a placement handle identifier and a reclaim group identifier; and
the memory controller is configured to:
determine a target reclaim unit based on the placement handle identifier and the reclaim group identifier; and
perform a write operation on the target reclaim unit in response to the third command.

15. The electronic system of claim 1, wherein the host is configured to:
send a fourth command, wherein the fourth command instructs to obtain a type of the reclaim unit handle; and
send the first command carrying the information related to the relative lifetime of the data written by the reclaim unit handle based on the type of the reclaim unit handle being a first type.

16. A method of operating a memory system, wherein the memory system supports a flexible data placement function, and the method comprises:
receiving a first command, wherein the first command carries information related to a relative lifetime of data written by a specified reclaim unit handle; and
performing a garbage collection operation on the data written by the specified reclaim unit handle based on the information related to the relative lifetime.

17. The method of claim 16, wherein the first command instructs to create a namespace, or the first command instructs to manage input / output behavior.

18. The method of claim 16, wherein performing the garbage collection operation on the data written by the specified reclaim unit handle based on the information related to the relative lifetime carried in the first command comprises:
performing the garbage collection operation on data written by different reclaim unit handles based on the information related to the relative lifetime, so as to reclaim data written by a first reclaim unit handle and data written by a second reclaim unit handle into a same first reclaim unit, and reclaim data written by a third reclaim unit handle into a second reclaim unit, wherein
a value of a relative lifetime of the data written by the third reclaim unit handle is different from values of relative lifetimes of the data written by the first reclaim unit handle and the data written by the second reclaim unit handle.

19. The method of claim 18, wherein a ratio of an absolute value of a difference between the value of the relative lifetime of the data written by the first reclaim unit handle and the value of the relative lifetime of the data written by the second reclaim unit handle to the value of the relative lifetime of the data written by the first reclaim unit handle is less than or equal to a preset value.

20. A memory system supporting a flexible data placement function, comprising:
a memory controller configured to:
receive a first command, wherein the first command carries information related to a relative lifetime of data written by a specified reclaim unit handle; and
perform a garbage collection operation on the data written by the specified reclaim unit handle based on the information related to the relative lifetime; and
a memory device coupled to the memory controller.
